(19) United States
(12) Patent Application Publication
(10) Pub. No.: US 2011/0141351 A1
(43) Pub. Date: Jun. 16, 2011

(54) HIGH DEFINITION MULTIMEDIA INTERFACE TO MINI DISPLAYPORT ADAPTER

(76) Inventor: Kelvin Yan, Brea, CA (US)

(21) Appl. No.: 12/637,293

(22) Filed: Dec. 14, 2009

(51) Int. Cl. H04N 7/01

(52) U.S. Cl. 348/445; 348/441; 348/E07.003

(57) ABSTRACT

The present invention relates in general to a device for conversion of electronic data, and more specifically, to a device that converts High Definition Multimedia Interface multimedia data to a format compatible for output through a Mini DisplayPort. The present invention describes a converter, comprising a source communication port adapted to receive multimedia data in a High Definition Multimedia Interface format, a processor adapted to generate multimedia in a Mini DisplayPort format based on the High Definition Multimedia Interface multimedia data, and an output communication port adapted to transmit the Mini Display port multimedia data.

### TECHNICAL FIELD OF THE INVENTION

The present invention relates in general to a device for conversion of electronic data, and more specifically, to a device that converts High Definition Multimedia Interface multimedia data to a format compatible for output through a Mini DisplayPort.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

Currently there are a number of electronic audio and video data transmission formats, such as High Definition Multimedia interface (“HDMI®”), digital or optical audio, digital visual interface, DisplayPort, or Mini DisplayPort.

Due to the large number of data formats, many electronic devices, such as high definition televisions, home theater components, and personal computers, contain a number of different input and output formats. However, in many situations, a consumer is faced with devices utilizing incompatible formats.

As such, in order to properly output audio or visual data from a source through their display or speaker system, the consumer has to utilize a separate device to convert the audio or visual data into a compatible format. Currently, however, adapters for the conversion of audio and video data formats are limited. Specifically, there is a lack of adapters for the conversion of HDMI® multimedia data to that of the Mini DisplayPort format.

The HDMI® format is a video and audio interface that transmits uncompressed digital video and audio data. DisplayPort is an alternative digital video and audio format to that of HDMI®. Mini DisplayPort is a derivative version of the DisplayPort format, comprising the same protocols of DisplayPort, but with a smaller physical port structure.

For the conversion and transmission of HDMI® multimedia data to that of Mini DisplayPort, no such adapter currently exists. As such, in order for one to transmit audio and video from an HDMI® source to a Mini DisplayPort receiver, one must use multiple adapter devices. Therefore, there is a need in the art for a device that converts a video and audio source into Mini DisplayPort format. Specifically, there is a need for a device that receives a HDMI® signal, converts the signal based upon a receiving Mini DisplayPort device's parameters, and outputs the signal in a Mini DisplayPort format. It is to these ends that the present invention has been developed.

### SUMMARY OF THE INVENTION

To minimize the limitations in the prior art, and to minimize other limitations that will be apparent upon reading and understanding the present specification, the present invention describes an adapter device, comprising a source communication port adapted to receive multimedia data in a HDMI® format, a processor adapted to generate multimedia in a Mini DisplayPort format based on the HDMI® multimedia data, and an output communication port adapted to transmit the Mini Display port multimedia data.

The present invention also describes a method of converting multimedia data comprising receiving multimedia data from a HDMI®, analyzing HDMI® multimedia data for parameters, comparing HDMI® parameters with Mini DisplayPort output capabilities, converting HDMI® multimedia data to Mini DisplayPort multimedia data, and transmitting the converted multimedia data through a Mini DisplayPort interface.

The present invention further describes a computer-readable medium including codes extractable by a computer, adapted to receive multimedia data from a HDMI®, analyze HDMI® multimedia data for parameters, compare HDMI® parameters with Mini DisplayPort output capabilities, convert HDMI® multimedia data to Mini DisplayPort multimedia data, and transmit the converted multimedia data through a Mini DisplayPort interface.

It is an objective of the present invention to convert HDMI® multimedia data into a compatible format for output through a Mini DisplayPort.

It is another objective of the present invention to provide a device that converts and outputs HDMI® multimedia data into a compatible format through Mini DisplayPort.

It is yet another objective of the present invention to convert HDMI® multimedia data of a first set of parameters into a Mini DisplayPort format of a second set of parameters.

Finally, it is yet another objective of the present invention to provide a converter that automatically relays electronic display identification data from a receiver to a source device for HDMI® multimedia data conversion into a Mini DisplayPort format.

These and other advantages and features of the present invention are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates a block diagram of an exemplary embodiment the present invention receiving multimedia data from an HDMI® source and transmitting it to a Mini DisplayPort receiver.

FIG. 2 illustrates a block diagram of an exemplary embodiment of a HDMI® to Mini DisplayPort adapter.

FIG. 3 illustrates a flow chart utilized by HDMI® to Mini DisplayPort adapter for the reception, conversion, and transmission of multimedia data from an HDMI® source to a Mini DisplayPort receiver.

### DETAILED DESCRIPTION OF THE DRAWINGS

In the following discussion that addresses a number of embodiments and applications of the present invention, reference is made to the accompanying drawings that form a part hereof, where depictions are made, by way of illustration, of specific embodiments in which the invention may be practiced. It is to be understood that other embodiments may be utilized and changes may be made without departing from the scope of the present invention.

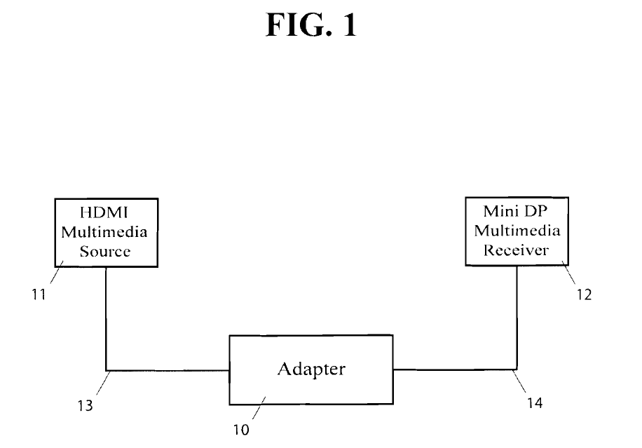

FIG. 1 illustrates a block diagram of an exemplary embodiment the present invention receiving multimedia data from an HDMI® source and transmitting it to a Mini DisplayPort receiver. FIG. 1 shows adapter 10, receiving a HDMI® multimedia data signal from HDMI® multimedia source 11 through HDMI® transmission cable 13, and transmitting a Mini DisplayPort signal to Mini DisplayPort multimedia receiver 12 through Mini DisplayPort transmission cable 14. Adapter 10 is designed to receive a HDMI® multimedia data signal and translate the multimedia data to a compatible output format for a Mini DisplayPort receiver.

In exemplary usage of the present invention, adapter 10 may be connected to HDMI® multimedia source 11 by HDMI® transmission cable 13, and connected to Mini DisplayPort multimedia receiver 12 by Mini DisplayPort transmission cable 14. In such an exemplary embodiment of adapter 10, multimedia data may be transferred from HDMI® multimedia source 11 to adapter 10 through HDMI® transmission cable 13, and adapter 10 may transfer multimedia data to Mini DisplayPort multimedia receiver 12 through Mini DisplayPort transmission cable 14.

HDMI® multimedia source 11 is a source of digital multimedia data that outputs multimedia data through an HDMI® interface. Such examples of an HDMI® multimedia source 11 include digital or high definition cable or satellite boxes, digital video disc or BLU-RAY® players, or next generation video game consoles such as the XBOX 360® or PLAYSTATION 3®. In an exemplary embodiment of HDMI® multimedia source 11, HDMI® multimedia source 11 may comprise any source of digital multimedia data that outputs through an HDMI® interface.

HDMI® transmission cable 13 is a multimedia data transmission device that has the data bandwidth capacity to transmit multimedia data over a distance, and may be connected to an HDMI® compatible interface at both ends of HDMI® transmission cable 13. In an exemplary usage of the present invention, HDMI® transmission cable 13 may be connected to an HDMI® interface in HDMI® multimedia source 11, and an HDMI® interface in adapter 10, such that multimedia data may be transferred over HDMI® transmission cable 13 from HDMI® multimedia source 11 to adapter 10.

When multimedia data is transferred from HDMI® multimedia source 11 to adapter 10, adapter 10 then translates the multimedia data to be compatible for output to Mini DisplayPort multimedia receiver 12 through Mini DisplayPort transmission cable 14.

Mini DisplayPort multimedia receiver 12 is any device capable of accepting multimedia data transmission through a Mini DisplayPort. Such examples of Mini DisplayPort multimedia receiver 12 include primarily APPLE® computers and accessories, such as the IMAC®, MACBOOK® or MACBOOK PRO®, or APPLE CINEMA DISPLAY®. In an exemplary embodiment of Mini DisplayPort multimedia receiver 12, Mini DisplayPort multimedia receiver 12 may comprise any receiver device that can receive multimedia data signals through a Mini DisplayPort interface.

Mini DisplayPort transmission cable 14 is a multimedia data transmission device that has the data bandwidth capacity to transmit multimedia data over a distance, and may be connected to a Mini DisplayPort compatible interface at both ends of Mini DisplayPort transmission cable 14. In exemplary usage of the present invention, Mini DisplayPort transmission cable 14 may be connected to a Mini DisplayPort interface in Mini DisplayPort multimedia receiver 12, and a Mini DisplayPort interface in adapter 10, such that multimedia data may be transferred over Mini DisplayPort transmission cable 14 from adapter 10 to Mini DisplayPort multimedia receiver 12.

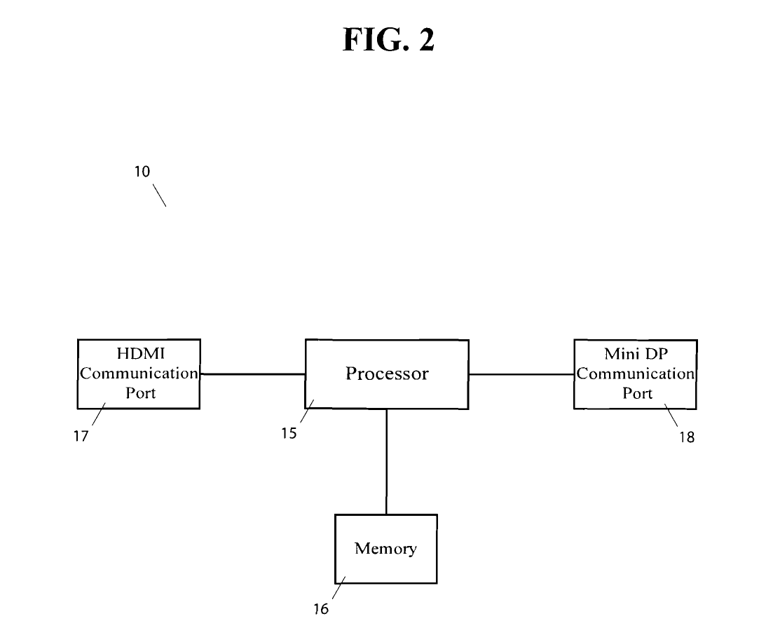

FIG. 2 illustrates a block diagram of an exemplary embodiment of adapter 10. FIG. 2 shows adapter 10, comprising processor 15, memory 16, HDMI® communication port 17, and Mini DisplayPort communication port 18. Adapter 10 is designed to receive a HDMI® signal through HDMI® communication port 17 and output a Mini DisplayPort signal through Mini DisplayPort communication port 18.

Processor 15 is a component of adapter 10 designed to translate and convert a multimedia data signal received from HDMI® multimedia source 11 to a format compatible for output to Mini DisplayPort multimedia receiver 12. In an exemplary embodiment of the present invention, multimedia data received by adapter 10 through HDMI® communication port 17 from HDMI® multimedia source 11 is relayed to processor 15 for analysis and conversion. After analysis and conversion, processor 15 relays the translated multimedia data to Mini DisplayPort communication port 18 for output to Mini DisplayPort multimedia receiver 12.

Processor 15 may utilize memory 16 for the analysis and translation of multimedia data. Memory 16 is a component of adapter 10 designed to aid in the translation and conversion of multimedia data, or for the storage of an external display information data (“EDID”) message. In an exemplary embodiment of the present invention, processor 15 may access memory 16 for the translation of multimedia data from an HDMI® format to a format compatible for output through a Mini DisplayPort interface. In an alternative embodiment of the present invention, processor 15 may access memory 16 to relay a stored EDID message. In other embodiments of the present invention, memory 16 may store a fixed EDID message, one that is permanently stored in memory and not received from Mini DisplayPort multimedia receiver 12.

HDMI® communication port 17 is a component of adapter 10 that is utilized for the reception and transmission of data to and from HDMI® multimedia source 11. In an exemplary embodiment of the present invention, HDMI® communication port 17 may comprise an HDMI® compatible HDMI® female interface port, wherein HDMI® transmission cable 13 may be connected for the reception of multimedia data from HDMI® multimedia source 11. Multimedia data that is received through HDMI® communication port 17 is relayed to processor 15 for analysis and translation. In another exemplary embodiment of the present invention, HDMI® communication port 17 may be utilized for the transmission of an EDID message to HDMI® multimedia source 11, wherein the EDID message may be stored in memory 16, or may be relayed from Mini DisplayPort multimedia receiver 12 through Mini DisplayPort communication port 18.

Mini DisplayPort communication port 18 is a component of adapter 10 that is utilized for the reception and transmission of data to and from Mini DisplayPort multimedia receiver 12. In an exemplary embodiment of the present invention, Mini DisplayPort communication port 18 may comprise a Mini DisplayPort compatible Mini DisplayPort female interface port, wherein Mini DisplayPort transmission cable 14 may be connected for the transmission of multimedia data to Mini DisplayPort multimedia receiver 12. Multimedia data that is transmitted through Mini DisplayPort communication port 18 is first analyzed and converted to a compatible output format by processor 15. In another exemplary embodiment of the present invention, Mini DisplayPort communication port 18 may be utilized for the reception of an EDID message from Mini DisplayPort multimedia receiver 12, wherein the EDID message by be stored in memory 16 for access or conversion by processor 15, or may be relayed to HDMI® multimedia source 11 by HDMI® communication port 17.

In an alternative embodiment of the present invention, adapter 10 may not only translate multimedia data from an HDMI® format to a format compatible for output through a Mini DisplayPort interface, but may also convert multimedia data depending upon the signal parameters of Mini DisplayPort multimedia receiver 12. In an exemplary embodiment of the present invention wherein an EDID message is received through Mini DisplayPort communication port 18 and stored in memory 16, processor 15 may convert the multimedia data received from HDMI® multimedia source 11 through HDMI® communication port 17 based upon the parameters contained in the EDID message.

For example, should HDMI® multimedia source 11 only be capable of outputting video data with a vertical resolution of 1080 pixels in progressive format, 1080p, while Mini DisplayPort multimedia receiver 12 may only be capable of displaying video data with a vertical resolution of 720 pixels in progressive format, 720p, then adapter 10 may downscale the multimedia data into a compatible output format for display in Mini DisplayPort multimedia receiver 12 through conversion by processor 15 and utilization of memory 16. In other embodiments of the present invention, adapter 10 may modify parameters such as frame rate, video resolution, aspect ratio, audio bit rate, the number of audio channels, audio or video channel bandwidth, luminance, or some other relevant multimedia data parameter.

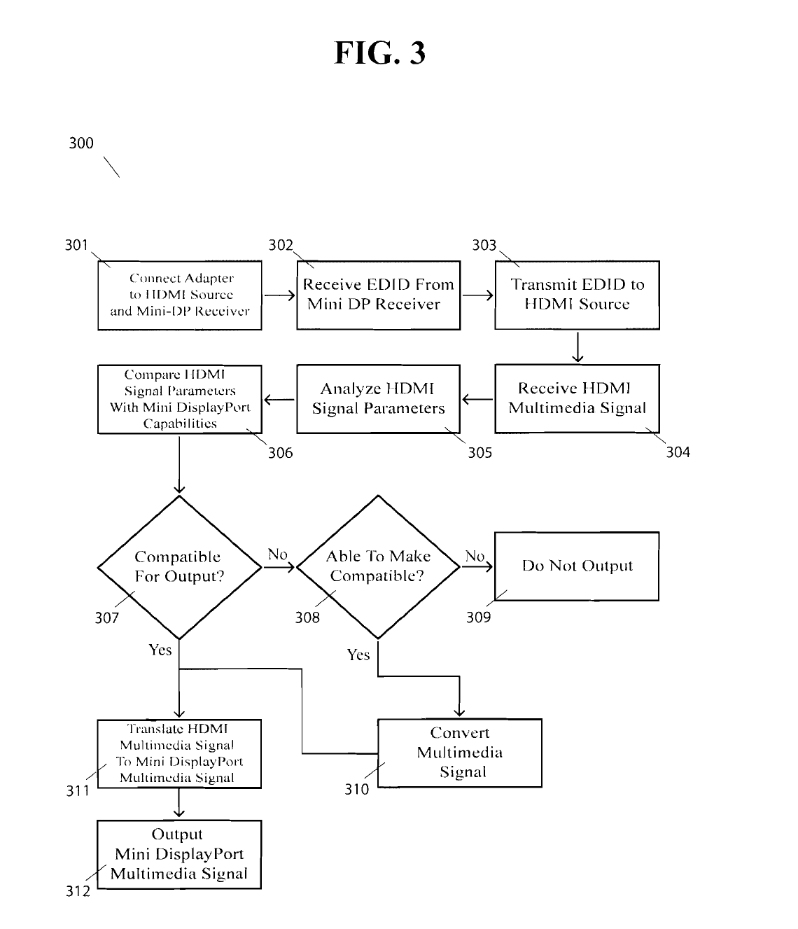

FIG. 3 illustrates a flow chart of method 300 utilized by adapter 10 for the reception, conversion, translation and transmission of multimedia data from a HDMI® multimedia source 11 to Mini DisplayPort multimedia receiver 12. Method 300 is explained in the order shown below; however, the following steps may be taken in any other conceivable sequence without deviating from the scope of the present invention.

In step 301, adapter 10 detects when connected to both HDMI® multimedia source 11 and Mini DisplayPort multimedia receiver 12. Adapter 10 detects connection with HDMI® multimedia source 11 through HDMI® communication port 17, and detects communication with Mini DisplayPort multimedia receiver 12 through Mini DisplayPort communication port 18.

In exemplary embodiments of HDMI® multimedia source 11 and Mini DisplayPort multimedia receiver 12, an EDID message is automatically transmitted from HDMI® multimedia source 11 to Mini DisplayPort multimedia receiver 12 when the devices are connected. As such, in an exemplary embodiment of the present invention, adapter 10 may act like an intermediary between HDMI® multimedia source 11 and Mini DisplayPort multimedia receiver 12, automatically sending a signal to HDMI® multimedia source 11 through HDMI® communication port 17 and Mini DisplayPort multimedia receiver 12 through Mini DisplayPort communication port 18 that a connection has been established. Once a connection with both HDMI® multimedia source 11 and Mini DisplayPort multimedia receiver 12 has been established, adapter 10 proceeds to step 302.

In step 302, adapter 10 receives an EDID message from Mini DisplayPort multimedia receiver 12 through Mini DisplayPort communication port 18. Processor 15 stores the EDID message in memory 16. In an alternative embodiment of the present invention wherein adapter 10 does not receive an EDID message form Mini DisplayPort multimedia receiver 12 through Mini DisplayPort communication port 18, adapter 10 may possess a fixed or standard EDID message permanently stored in memory 16.

In step 303, adapter 10 transfers the EDID message stored in memory 16 to HDMI® multimedia source 11 via HDMI® communication port 17. The EDID message stored in memory 16, whether permanently fixed or previously written into memory 16 in step 302 by processor 15, is accessed by processor 15 and transferred to HDMI® multimedia source 11 via HDMI® communication port 17. Once the EDID message has been transmitted to HDMI® multimedia source 11, adapter 10 proceeds to step 304.

In step 304, adapter 10 awaits reception of multimedia data from HDMI® multimedia source 11. Multimedia data is received from HDMI® multimedia source 11 through HDMI® communication port 17. In an exemplary embodiment of the present invention, a continuous stream of multimedia data is received by HDMI® communication port 17. As multimedia data is received from HDMI® multimedia source 11, adapter 10 proceeds to step 305. In step 305, adapter 10 analyzes the parameters of the multimedia data transferred from HDMI® multimedia source 11. In an exemplary embodiment of the present invention, processor 15 stores the parameters of the multimedia data transferred from HDMI® multimedia source 11 in memory 16.

In step 306, adapter 10 compares the parameters of the multimedia data transferred from HDMI® multimedia source 11 with those of compatible with Mini DisplayPort multimedia receiver 12. In an exemplary embodiment of the present invention, processor 15 compares the parameters stored in memory 16 in step 305 with the parameters contained in the EDID message stored received or accessed in step 302.

In step 307, processor 15 determines if conversion of parameters of the multimedia data received from HDMI® multimedia source 11 is necessary in order to be translated for output to Mini DisplayPort multimedia receiver 12. If processor 15 determines that the multimedia data received from HDMI® multimedia source 11 is compatible for translation and output to Mini DisplayPort multimedia receiver 12, adapter 10 will proceed to step 311. If, however, processor 15 determines that conversion is necessary to make the multimedia data received from HDMI® multimedia source 11 compatible for translation and output to Mini DisplayPort multimedia receiver 12, adapter 10 will proceed to step 308.

In step 308, processor 15 determines if it is indeed possible to convert the multimedia data received from HDMI® multimedia source 11 to a signal with the parameters necessary for output Mini DisplayPort multimedia receiver 12. For example, should processor 15 be unable to resolve a conflict between the resolution of the multimedia data received from HDMI® multimedia source 11 and the parameter requirements of Mini DisplayPort multimedia receiver 12 necessary for input, then adapter 10 will be unable to make the multimedia data compatible for output to Mini DisplayPort multimedia receiver 12. If conversion is not possible, adapter 10 will proceed to step 309. However, if conversion is possible, adapter 10 will proceed to step 310.

In step 309, should adapter 10 determine that it is unable to make the multimedia data received from HDMI® multimedia source 11 compatible for output to Mini DisplayPort multimedia receiver 12, adapter 10 will not output multimedia data to Mini DisplayPort multimedia receiver 12.

In step 310, adapter 10 converts the multimedia data received from HDMI® multimedia source 11 to data that has the parameters compatible for output to Mini DisplayPort multimedia receiver 12. In an exemplary embodiment of the present invention, processor 15 may carry out the conversion of multimedia data to the parameters specified in the EDID message accessed or stored in memory 16 in step 302. Processor 15 may utilize memory 16 during the conversion process. Once conversion has been completed, adapter 10 will proceed to step 311.

In step 311, adapter 10 translates the multimedia data to a format compatible for output to Mini DisplayPort multimedia receiver 12 via Mini DisplayPort communication port 18. In an exemplary embodiment of the present invention, processor 15 may utilize memory 16 to translate the multimedia data for output in a Mini DisplayPort format. Once the multimedia data has been translated by adapter 10, adapter 10 proceeds to step 312.

In step 312, adapter 10 outputs the translated multimedia data to Mini DisplayPort multimedia receiver 12 via Mini DisplayPort communication port 18. In an exemplary embodiment of the present invention, a continuous stream of multimedia data is outputted to Mini DisplayPort multimedia receiver 12 after it is translated by processor 15.

A HDMI® to Mini DisplayPort adapter has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. An adapter device, comprising:
a source communication port adapted to receive multimedia data in a High Definition Multimedia Interface format;
a processor adapted to generate multimedia in a Mini DisplayPort format based on the High Definition Multimedia Interface multimedia data; and
an output communication port adapted to transmit the Mini Display port multimedia data.

2. The converter of claim 1, wherein the source communication port is adapted to transmit an extended display identification data message.

3. The converter of claim 2, wherein the output communication port is adapted to receive the extended display identification data message.

4. The converter of claim 3, wherein the processor is adapted to relay the extended display identification data message from the output communication port to the source communication port.

5. The converter of claim 3, wherein the processor is adapted to modify the extended display identification data message.

6. The converter of claim 2, further comprising a memory, wherein the memory is adapted to store a fixed extended display identification data message.

7. The converter of claim 6, wherein the processor is adapted to relay the fixed extended display identification data message from memory to the source communication port.

8. The converter of claim 1, wherein the High Definition Multimedia Interface multimedia data is configured with a first video resolution and the Mini DisplayPort multimedia data is configured with a second video resolution.

9. The converter of claim 8, wherein the first video resolution is not equal to the second video resolution.

10. The converter of claim 1, wherein the High Definition Multimedia Interface multimedia data is configured with a first frame rate and the Mini DisplayPort multimedia data is configured with a second frame rate.

11. The converter of claim 10, wherein the first frame rate is not equal to the second frame rate.

12. The converter of claim 1, wherein the High Definition Multimedia Interface multimedia data is configured with a first audio bit rate and the Mini DisplayPort multimedia data is configured with a second audio bit rate.

13. The converter of claim 1, wherein the High Definition Multimedia Interface multimedia data is configured with a first set of audio channels and the Mini DisplayPort multimedia data is configured with a second set of audio channels.

14. A method of converting multimedia data comprising:
receiving multimedia data from a High Definition Multimedia Interface;
analyzing High Definition Multimedia Interface multimedia data for parameters;
comparing High Definition Multimedia Interface parameters with Mini DisplayPort output capabilities;
converting High Definition Multimedia Interface multimedia data to Mini DisplayPort multimedia data; and
transmitting the converted multimedia data through a Mini DisplayPort interface.

15. The method of claim 14, further comprising receiving an extended display identification data message from a Mini DisplayPort interface.

16. The method of claim 14, further comprising transmitting an extended display identification data message through a High Definition Multimedia Interface.

17. The method of claim 15, further comprising the conversion of an extended display identification data message according to the set of Mini DisplayPort output capabilities.

18. The method of claim 14, wherein High Definition Multimedia Interface multimedia data parameters comprise:
video resolution;
frame rate;
aspect ratio;
audio bit rate;
number of audio channels;
channel bandwidth;
display size;
product type;
manufacturer;
luminance;
or some other video electronic standard data parameter.

19. A computer-readable medium including codes extractable by a computer, adapted to;
receive multimedia data from a High Definition Multimedia Interface;
analyze High Definition Multimedia Interface multimedia data for parameters;
compare High Definition Multimedia Interface parameters with Mini DisplayPort output capabilities;
convert High Definition Multimedia Interface multimedia data to Mini DisplayPort multimedia data; and
transmit the converted multimedia data through a Mini DisplayPort interface.
